(19) United States
(12) Patent Application Publication
(10) Pub. No.: US 2012/0248776 A1
(43) Pub. Date: Oct. 4, 2012

(54) WAVE ENERGY EXTRACTION SYSTEM USING AN OSCILLATING WATER COLUMN ATTACHED TO THE COLUMNS OF AN OFFSHORE PLATFORM

(75) Inventors: Ali Mohammad Baghaei Nanehkaran, Wahroonga (AU); Tom Deniss, Randwick (AU)

(73) Assignee: OCEANLINX LTD., Macquarie Park, New South Wales (AU)

(21) Appl. No.: 13/518,734

(22) PCT Filed: Dec. 24, 2010
(86) PCT No.: PCT/AU10/01747

§ 371 Date: Jun. 22, 2012

(30) Foreign Application Priority Data
Dec. 24, 2009 (AU) 2009906282
Feb. 26, 2010 (AU) 2010900844
Apr. 19, 2010 (AU) 2010901642

(51) Int. Cl. F03B 13/22; F03B 3/00; F03B 3/04

(52) U.S. Cl. 290/53; 415/182.1; 415/221

(57) ABSTRACT

An offshore platform includes a support structure for supporting a workstation in a body of water at an offshore location. The support structure has a mounting formation and at least one duct is mounted to the mounting formation. The duct is configured to receive an oscillating water column from the body of water wherein oscillations of the oscillating water column generate a fluid flow for driving an energy extraction module.

### FIELD OF THE INVENTION

The present invention relates generally to sustainable energy generation. More particularly, the present invention relates to improvements in ocean wave energy extraction systems and methods therefor.

### BACKGROUND TO THE INVENTION

The following discussion of the prior art has been provided in order to place the invention in an appropriate technical context and allow the advantages of it to be more fully appreciated. However, any discussion of the prior art throughout the specification should not be considered as an express or implied admission that such prior art is widely known or forms part of common general knowledge in the field.

Environmental concerns and the awareness of the finite resources of traditional combustible hydrocarbon fuel sources has led to research into sustainable non-polluting energy sources such as waves, wind, tidal, geothermal and solar.

Numerous different types of wave power generation systems have been proposed. A number of the systems are based on the principal of using the vertical motion inherent in the movement of waves to effect a rotary movement of a turbine to drive directly or indirectly a generator to produce electricity. An inherent disadvantage of such systems arises from the fact that the performance of the systems is strongly dependent on the orientation of the system with respect to incoming ocean waves. Some attempts have been made to overcome the problems associated with changes in the direction of the prevailing ocean wave. However, such systems can be prohibitively expensive and thus not commercially viable. The use of renewable energy sources necessarily requires reduced cost outlays in order to make such systems commercially viable and provide a return on investment for investors.

The configuring of individual energy extraction units to be customized to a particular orientation relative to the prevailing ocean wave necessarily gives rise to increases in the complexity of design and construction and thus associated increases in the cost of these units and the system as a whole.

Another disadvantage of many known wave power generation systems is that such systems commonly include multiple ducts connected to a single power conversion means, such as a turbine, which necessarily requires a complicated system of merging the various fluid flows from the separate oscillating water columns (OWC). The merging of such flows again necessarily increases the design and manufacturing costs of these wave power generation systems.

It has been found that the additional costs associated with trying to deal with the above issues are often so high that they can render systems commercially unviable. Furthermore, the significant capital outlay required to setup those systems which have been proposed to date often acts as a barrier to commercial investment. In particular, the extent of the capital outlay can often act as a deterrent to investors, as the return on investment is limited to some extent by the relationship between the capital outlay for the system and the operating efficiency of the system.

The efficiency of ocean wave energy extractors can also be negatively impacted by the system floating up and down with the respect to the seabed as waves pass the system. Mooring systems designed to counteract these undesired fluctuations are typically complex and prohibitively expensive. Furthermore, such mooring systems are generally inadequate in resisting the fluctuating movement of the system.

It is an object of the present invention to overcome or ameliorate one or more of the disadvantages of the prior art, or at least to provide a useful alternative.

### SUMMARY OF THE INVENTION

According to a first aspect of the invention, there is provided an offshore platform including:

a support structure for supporting a workstation in a body of water at an offshore location, the support structure having a mounting formation; and

at least one duct mounted to the mounting formation, the duct being configured to receive an oscillating water column from the body of water wherein oscillations of the oscillating water column generate a fluid flow for driving an energy extraction module.

Preferably, two or more ducts are mounted to the mounting formation. The or each duct is preferably mounted to the mounting formation such that an inlet of the duct is submerged within the body of water and an outlet of the duct is above the body of water. Preferably, the inlet of each duct is located below the lowest anticipated wave trough and the outlet is above the highest anticipated wave peak. Each duct is preferably mounted such that the inlet of the duct is held at a predetermined fixed height above the floor of the body of water (e.g. the ocean floor).

Each duct is preferably held at the same height above the ocean floor. In other embodiments, at least two of the ducts are held at different heights above the ocean floor. In some embodiments, each duct is held at a different height above the ocean floor. Preferably, the height at which each duct is held above the ocean floor is substantially fixed, in use.

Preferably, the support structure is positioned in the body of water such that the mounting formation is arranged at approximately the mean surface level of the body of water, in use.

The support structure is preferably in the form of a rigid column or pylon. In certain embodiments, the support structure includes two or more rigid columns, the two or more rigid columns being interconnected and held in fixed spaced apart relation relative to one another. The rigid columns are preferably arranged in the body of water so as to have a substantially vertical orientation. In certain preferred embodiments, the support structure includes four rigid columns. Preferably, the four rigid columns are arranged to form a square or rectangular formation, when viewed from above. In certain embodiments, the rigid pylon is formed of steel and/or concrete.

Preferably, the offshore platform is immobile. Preferably, the rigid columns are fixedly anchored to the ocean floor. In other embodiments, the rigid columns of the support structure are secured to the ocean floor by a mooring system. In some embodiments, a ballast element or system is attached to the rigid columns to stabilize the support structure.

The two or more ducts are preferably arranged in a symmetrical formation about the support structure. In certain embodiments, the same symmetrical formation is arranged about each column of the support structure. Preferably, the ducts circumferentially arranged about the leg of the offshore structure. The ducts are preferably arranged in a circular formation. In other preferred embodiments, the ducts are arranged in an asymmetrical formation about one or more of the columns of the support structure. In yet other forms, a combination of both symmetrical and asymmetrical formations are mounted to the various columns of the support structure.

In certain embodiments, the mounting means is adapted to reinforce the support structure to thereby increase the load rating of the support structure. In other embodiments, separate reinforcing means is fixed to the support structure to increase its load rating for supporting the static and dynamic forces applied to the support structure by the ducts mounted thereto, in use. The reinforcing means is preferably fixed on or adjacent to the mounting formation of the support structure.

In some preferred embodiments, the mounting formation is in the form of a recess such that the duct is mounted within the recess. In certain preferred forms, the mounting formation includes a discrete recess for mounting each duct. In other forms, the recess extends uninterrupted around the support structure such that the mounting formation is a region of reduced cross-sectional area of the support structure. In some embodiments, the recess is configured such that the duct is received within the recess such that an outer surface of the duct is substantially flush with an outer surface of the support structure. Alternatively, the recess can be configured such that a portion of the duct is received within the recess and the remainder of the duct stands proud of the outer surface of the support structure.

In other preferred embodiments, the mounting formation is in the form of a projection which projects outwardly from an outer surface of the support structure. The mounting formation may include a plurality of projections, each projection being configured for mounting a separate duct. Alternatively, the ducts can be mounted to pairs or groups of projections. In other forms, the projection is in the form of a continuous band or annulet encircling the support structure such that two or more ducts can be mounted to the band or annulet.

Preferably, the energy extraction module includes a turbine in fluid communication with the duct such that the turbine can be driven by the fluid flow generated by the oscillating water column. The fluid flow generated by the oscillating water column is preferably an airflow, more preferably, a bidirectional airflow.

In certain embodiments, the bidirectional airflow from each duct is used to drive a single turbine. In other embodiments, a separate turbine is associated with each duct and driven by the airflow generated by the associated oscillating water column.

The energy extraction module preferably includes an electrical generating means coupled to the or each turbine for generating electrical energy. Preferably, the electrical generating means is an electrical generator. In certain embodiments, each energy extraction module has an electrical generator configured for rotation by the associated turbine to generate electrical energy. In other embodiments, a single electrical generator is coupled to and rotated by each turbine of the energy extraction modules.

In certain embodiments, the electrical energy generated by the electrical generator or generators is fed to an electrical grid. In other forms, the electrical energy fed to an energy storage means such, for example, a battery for later use. In some preferred embodiments, the stored energy is used to supply power to the workstation.

The offshore platform is preferably an oil rig or a gas rig. Preferably, the workstation is a deck of the oil or gas rig. The workstation is preferably held above the body of water by the support structure.

In some embodiments, each energy extraction module is connected directly to the outlet of the associated duct. In other forms, a separate flow path in the form of, for example, a conduit extends from the outlet of the duct and connects to the turbine of the energy extraction module. The conduit can be mounted to run along or adjacent to the outer surface of the support structure. Alternatively, the support structure can have an internal passageway defining the flow path of the bidirectional airflow used to drive the turbine.

It will be appreciated by those skilled in the art that the conduit and internal flow paths advantageously enables the energy extraction modules to be positioned at a variety of different positions relative to the ducts. In some embodiments, the energy extraction modules are mounted on the support structure near to the associated duct. In other embodiments, a support structure is arranged beneath the workstation for supporting the energy conversion modules. In yet further embodiments, the energy extraction modules are arranged on an upper working surface of the workstation or deck.

In certain preferred embodiments, the duct is straight. In other preferred embodiments, the duct is one of L-shaped, U-shaped, J-shaped or is otherwise configured such that the oscillating water column inside the duct changes course as the water flows through the duct.

In some preferred embodiments, each duct is generally J-shaped such that one section of the duct is longer than the other. The inlet section is preferably shorter than the second outlet section. The inlet and outlet openings are preferably arranged in operatively upper surfaces of the first and second sections of the duct, respectively.

Preferably, the duct of each energy extraction module has at least a first section and a second section, the first and second sections being substantially parallel such that the oscillating water column changes course by approximately 180 degrees as the water column flows from the first section to the second section, or vice versa. In other embodiments, the duct of each energy extraction module has at least a first section and a second section, the first and second sections being substantially perpendicular such that the oscillating water column changes course by approximately 90 degrees as the water column flows from the first section to the second section, or vice versa. In certain embodiments, the duct has three or more sections wherein the oscillating water column changes course as the water column flows from one section to the next. The duct is preferably configured such that the oscillating water column has a boustrophedonic flow path.

Preferably, each duct and each energy extraction module is of a substantially identical configuration. In other forms, the ducts and modules have different configurations in order to account for the intended orientation of a particular module relative to the prevailing ocean wave and/or to assist in maintenance procedures.

Preferably, the duct of each module is mounted to the offshore structure by a mounting means. The mounting means is preferably a mounting bracket, more preferably a rigid mounting bracket. Preferably, each duct is mounted in a substantially vertical orientation. The longitudinal axis of each duct (or preferably each section of duct) is preferably substantially parallel to the longitudinal axis of the pylon to which the duct is securely mounted.

Each duct is preferably arranged such that an air chamber is formed between the oscillating water column and the outlet opening, in use.

According to a second aspect of the invention, there is provided a support structure for an offshore platform located in a body of water, the support structure including:

a column;

a mounting formation associated with the column; and

at least one oscillating water column duct for a wave energy extraction system, the oscillating water column duct being mounted to the mounting formation such that the duct is held at a predetermined fixed height relative to the mean surface level of the body of water.

Preferably, the mounting means is adapted to reinforce the column to thereby increase the load rating of the column. In other embodiments, separate reinforcing means is fixed to the column to increase its load rating for supporting the static and dynamic forces applied to the column by the at least one oscillating water column duct mounted thereto. The reinforcing means is preferably fixed on or adjacent to the mounting formation of the column.

In certain preferred embodiments, the column defines a flow passage of a fluid flow generated by an oscillating water column oscillating within the duct wherein the fluid flow can be used to drive an energy extraction module. The flow passage may be an internal hollowed passage allowing flow inside the column. Alternatively, the flow passage may be defined by a conduit arranged in a groove formed in an outer surface of the column.

According to a third aspect of the invention, there is provided a wave energy extraction system including:

a support structure;

two or more energy extraction modules connected to the support structure, each energy extraction module having a duct for receiving an oscillating water column, a turbine in fluid communication with the duct such that the turbine can be driven by a fluid flow generated by the oscillating water column, and an electrical generator operatively coupled to the turbine for generating electrical energy;

wherein, the two or more energy extraction modules are of a substantially identical configuration and arranged in a symmetrical formation such that the combined total electrical energy generated by the two or more energy extraction modules is substantially constant regardless of the prevailing wave direction.

Preferably, the support structure is a support frame for holding the ducts of the energy extraction modules in fixed spaced relation relative to each other. The support structure preferably defines a central axis. Preferably, the symmetrical formation of the two or more energy extraction modules is arranged about the central axis, more preferably, coaxially arranged about the central axis.

The two or more energy extraction modules are preferably positioned in a body of water, such as an ocean, such that each water column oscillates independently in response to the rise and fall of waves passing the associated duct.

Preferably, the two or more energy extraction modules are arranged in the ocean to face in different directions relative to each other and thus relative to the prevailing ocean wave. In some embodiments, the energy extraction modules include two or more groups of energy extraction modules wherein a first group of modules face in a different direction relative to a second group of modules.

In certain preferred embodiments, the two or more energy extraction modules are arranged in a circular formation about the central axis. In one preferred embodiment, the circular formation includes six energy extraction modules concentrically arranged about the central axis, wherein one energy extraction module faces directly towards the incoming wave, one module faces at +60 degrees relative to the incoming wave, one module faces at −60 degrees relative to the incoming wave, one module faces at +120 degrees relative to the incoming wave, one module faces at −120 degrees relative to the incoming wave, and one module faces at +180 degrees relative to the incoming wave.

It will be appreciated that the symmetrical formation of the energy extraction modules is not limited to circular formations, or formations having six modules as described above, but can be any suitable symmetrical formation and can include any suitable or desired number of modules to suit desired design and/or performance requirements. In particular, the symmetrical formation could be any suitable symmetrical polygonal formation.

In certain embodiments, the energy extraction modules are configured to be in side-by-side relationship. In various embodiments, the modules which are in side-by-side relation share common side walls. It will be appreciated that the common side walls simplify the design and construction of the wave energy extraction system and advantageously reduces the associated construction costs.

It will also be appreciated that with each substantially identical energy extraction module facing in a different direction relative to the others, the oscillating water column associated with each module will preferably oscillate between peaks and troughs of different magnitudes, depending on the direction which that energy extraction module is facing relative to the prevailing ocean wave.

Preferably, the support frame and energy extraction modules are held in a desired position and orientation in the body of water by a mooring system. The mooring system preferably holds the duct at a pre-determined height above the floor of the body of water. Preferably, the mooring system is a tensioned-mooring system. In certain embodiments, a buoyancy element or mechanism for facilitating floatation of the support frame and energy extraction modules can be used in combination with the mooring system to help maintain the ducts at the pre-determined heights above the floor of the body of water.

In other preferred embodiments, the mooring system can be selected from the group including fixed-mooring systems, floating-mooring systems and slack-mooring systems.

In certain preferred embodiments, only a single mooring is required for the entire wave energy extraction system. It will be appreciated by those skilled in the art that the use of a single mooring system is advantageous as this significantly reduces the complexity of the overall structure and thus also reduces the overall cost associated with constructing, commissioning and maintenance procedures.

It will be appreciated that in those embodiments in which the energy extraction modules are held in fixed relation relative to the prevailing ocean wave, the performance of each module will depend on the orientation of that particular module with respect to the incoming wave. For example, an energy extraction module which faces directly at the incoming wave preferably operates at close to 100% working capacity whereas, those modules which face away from the incoming wave via an angle ‘α’, will operate below the maximum capacity depending on the angle of orientation. In certain embodiments, the working capacity of a module decreases as the angle at which the module faces away from the wave increases.

For example, energy extraction modules orientated at an angle of 60 degrees relative to the incoming wave may operate at 85% capacity, modules angled at 120 degrees relative to the incoming wave may operate at approximately 75% capacity and those facing away from the incoming wave (ie orientated at 180 degrees) may operate at approximately 60% capacity. It will be appreciated that the figures listed above are for illustrative purposes only and that the actual performance of the energy extraction modules will depend on the configuration of the modules and the prevailing wave activity.

Preferably, if the wave direction changes, each energy extraction module will operate at a different working capacity depending on its angle of orientation with respect to the direction of the incoming wave. In particular, as the wave direction changes, at least some of the units will be oriented at a lesser angle or will face more directly towards the incoming wave and will begin to operate at a higher capacity. Similarly, some energy extraction modules will be orientated at a greater angle or face further away from the incoming wave and therefore operate at a lower working capacity. Preferably, however, the total power output of the system will remain essentially the same for all wave directions.

The fluid flow generated by each oscillating water column is preferably bi-directional. Preferably, the fluid associated with each fluid flow is one of a gas and a liquid. In certain embodiments, the fluid flow is an airflow. In these embodiments, the turbine may be, for example, an air-driven turbine, which is preferably, but not necessarily, located above the mean surface level of the body of water. In other embodiments, the fluid flow is a water flow. In these embodiments, the turbine may be, for example, a water turbine which is preferably, but not necessarily, submerged below the mean surface level of the body of water. Accordingly, it will be appreciated that the turbine may be driven directly or indirectly by the fluid flow associated with the oscillating water column.

Preferably, the duct has an inlet portion to be submerged in the body of water, such as an ocean, and an outlet portion configured to extend above the body of water when the inlet portion is submerged. The inlet portion defines an inlet opening for receiving the oscillating water column, whereby the oscillating water column oscillates in response to the rise and fall of waves passing the duct.

Each inlet opening preferably faces away from the central axis. In other embodiments, each inlet opening is configured to face towards the central axis. In yet other forms, some ducts are arranged such that their inlet opening faces away from the central axis, and some inlet openings face towards the central axis.

Preferably, the outlet portion defines an air chamber above the oscillating water column, whereby upward pressure from a wave peak causes the oscillating water column to rise creating a fluid flow in the form of an air flow which passes through an outlet opening of the duct. As a wave trough passes the duct, downward pressure is exerted on the oscillating water column such that the air flows into the outlet chamber towards the oscillating water column. The airflow, in either direction, acts on the associated turbine to induce a mechanical rotation of the rotor of the turbine.

Preferably, the turbine operates unidirectionally in response to the bi-directional fluid flow. Each turbine may be an air-driven turbine or a water-driven turbine (ie pneumatic or hydraulic). In certain embodiments, the turbine is arranged such that its axis of rotation is transverse to a longitudinal axis of the duct. In other embodiments, the turbine is arranged such that its axis of rotation is substantially parallel to the longitudinal axis of the duct. In some embodiments, the axis of rotation of the turbine is coaxial with the duct.

Preferably, the duct has a constant inner cross-sectional area. The inner cross-sectional area is preferably one of square, rectangular and circular. It will be appreciated that the inner cross-sectional area of the duct may be any suitable shape, including irregular shapes and may vary in size and shape along the length of the duct.

In some embodiments, each duct has tapered side walls, preferably with the widest point at or near the inlet opening of the associated duct. It will be appreciated that the use of tapered ducts facilitates the construction of circular or polygonal formations, particular those having modules sharing common side walls.

The ocean wave energy extraction system may include a mooring system for mooring the duct in a desired location. The mooring system is preferably one of a fixed-mooring system, a floating-mooring system, a tensioned-mooring system and a slack-mooring system.

The ocean wave energy extraction system may include a buoyancy element for facilitating floatation of the energy extraction modules. In certain embodiments, the buoyancy element is mounted to the ducts and/or the support frame.

Preferably, each energy extraction module has a dynamic resonance control for dynamically varying the resonant frequency of the duct of the associated module. The dynamic resonance control is preferably used to match the resonant frequency of the ducts to the frequency of the prevailing ocean wave. In certain embodiments, the dynamic resonance control includes a tuning aperture in a wall of the associated duct and a selectively moveable cover or gate for selectively adjusting the size of the tuning aperture between a fully opened position and a closed position. The cover is preferably moveable to intermediate positions between the fully opened and closed positions in order to provide fine tuning of the variable length of the duct to the frequency of the prevailing ocean wave. Preferably, the cover is slideably mounted over the tuning aperture.

In other preferred forms, the dynamic resonance control includes means for selectively adjusting the length of the duct to thereby adjust the resonant frequency of the duct to substantially accord with the period of the prevailing ocean wave, and to allow for changes to the period of the prevailing wave over time. In various embodiments, the duct has a telescopic configuration for varying the length of the duct. The telescopic configuration of the duct may include a plurality of discrete portions, such as tubes, arranged to facilitate relative sliding movement of the tubes to vary the length of the duct. Each pair of telescopic segments preferably has an associated locking means to lock the tubes relative to one another to set the desired length of the duct.

Preferably, the dynamic resonance control includes sensing means for sensing the magnitude of the oscillations the oscillating water column within the duct, which are indicative of the period of the prevailing ocean wave. The cover is preferably in communication with the sensing means such that signals from the sensor are used to move the cover to tune the resonant frequency of the duct to correspond with that of the current wave conditions.

Preferably, the duct is configured such that the sensing means measures vertical oscillations of the OWC, and the tuning aperture and gate are arranged on an upper wall of the inlet section of the duct such that the gate moves substantially horizontally in response to the sensor signals to open or close the tuning aperture.

According to a fourth aspect of the invention, there is provided a wave energy extraction system including:

two or more energy extraction modules connected in fixed relation relative to each other, each energy extraction module having a duct for receiving an oscillating water column, a turbine in fluid communication with the duct such that the turbine can be driven by a fluid flow generated by the oscillating water column, and an electrical generator operatively coupled to the turbine for generating electrical energy;

wherein, the two or more energy extraction modules are of a substantially identical configuration and arranged in a symmetrical formation such that the combined total electrical energy generated by the two or more energy extraction modules is substantially constant regardless of the prevailing wave direction.

According to a fifth aspect of the invention, there is provided a wave energy extraction system including:

an offshore rigid support structure located in a body of water;

at least one energy extraction module securely mounted to the offshore rigid support structure, the or each energy extraction module having a duct for receiving an oscillating water column from the body of water, and a turbine in fluid communication with the duct such that the turbine can be driven by a fluid flow generated by the oscillating water column;

wherein, the duct of the or each energy extraction module is held at a predetermined height above an ocean floor of the body of water.

Preferably, the offshore rigid support structure is immobile. The offshore rigid support structure is preferably fixedly anchored to the ocean floor. The support structure is preferably in the form of a rigid pylon or column. In certain embodiments, the rigid pylon is formed of steel and/or concrete. Preferably, the rigid pylon is a leg of an offshore platform. The offshore platform is preferably an oil rig or a gas rig.

Preferably, the wave energy extraction system includes two or more energy extraction modules. The duct of each module is preferably held at the same height above the ocean floor. In other embodiments, at least two of the ducts are held at different heights above the ocean floor. In some embodiments, each duct is held at a different height above the ocean floor. Preferably, the height at which each duct is held above the ocean floor is substantially fixed, in use.

The wave energy extraction system preferably includes electrical generating means coupled to the or each turbine for generating electrical energy. Preferably, the electrical generating means is an electrical generator. In certain embodiments, each energy extraction module has an electrical generator configured for rotation by the associated turbine to generate electrical energy. In other embodiments, the wave energy extraction system includes a single electrical generator, the single electrical generator being coupled to and rotated by each turbine of the energy extraction modules.

In certain embodiments, the electrical energy generated by the electrical generator or generators is fed to an electrical grid. In other forms, the electrical energy fed to an energy storage means such, for example, a battery for later use. In some preferred embodiments, the stored energy is used to supply power to the offshore platform.

Preferably, each energy extraction module is of a substantially identical configuration. In other forms, the modules have different configurations in order to account for the intended orientation of a particular module relative to the prevailing ocean wave.

The two or more energy extraction modules are preferably arranged in a symmetrical formation the leg of the offshore platform. In certain embodiments, the same symmetrical formation is arranged about each leg of the offshore platform. In other preferred embodiments, the energy extraction modules are arranged in an asymmetrical formation about one or more of the legs of the offshore platform. In yet other forms, a combination of both symmetrical and asymmetrical formations are mounted to the various legs of the offshore platform.

Preferably, the duct of each module is mounted to the offshore structure by a mounting means. The mounting means is preferably a mounting bracket, more preferably a rigid mounting bracket.

Preferably, the ducts circumferentially arranged about the leg of the offshore structure. The ducts are preferably arranged in a circular formation. In some embodiments, each duct is mounted to the offshore structure such that each duct abuts the offshore structure. In other forms, each duct is mounted so as to be spaced from the leg of the pylon to which it is mounted.

Preferably, the duct of each energy extraction module has at least a first section and a second section, the first and second sections being substantially parallel such that the oscillating water column changes course as the water column flows from the first section to the second section, or vice versa. Preferably, each duct having at least a first section and a second section is substantially U-shaped. In certain embodiments, the duct has three or more sections wherein the oscillating water column changes course as the water column flows from one section to the next. The duct is preferably configured such that the oscillating water column has a boustrophedonic flow path.

Preferably, each duct is mounted in a substantially vertical orientation. The longitudinal axis of each duct (or preferably each section of duct) is preferably substantially parallel to the longitudinal axis of the pylon to which the duct is securely mounted. Each duct preferably has an inlet opening submerged within the body of water, and an outlet opening arranged above the body of water such that an air chamber is formed between the oscillating water column and the outlet opening, in use. The inlet opening is preferably arranged, in use, above the bend or join between the first and second sections of the duct. Preferably, the inlet opening is submerged such that the inlet opening is arranged below the anticipated lowest wave trough.

According to a sixth aspect of the invention, there is provided a wave energy extraction system including:

at least one energy extraction module, each energy extraction module having a duct for receiving an oscillating water column, a turbine in fluid communication with the duct such that the turbine can be driven by a fluid flow generated by the oscillating water column;

wherein, the duct has at least a first section and a second section, the first and second sections being substantially parallel such that the oscillating water column changes course as the water column flows from the first section to the second section, or vice versa.

Preferably, the first section and second sections of each duct configured such that the or each duct is substantially U-shaped. In certain embodiments, the duct has three or more sections wherein the oscillating water column changes course as the water column flows from one section to the next. The duct is preferably configured such that the oscillating water column has a boustrophedonic flow path.

Preferably, each duct is mounted in a substantially vertical orientation, in use. The longitudinal axis of each duct (or preferably each section of duct) is preferably substantially parallel to the longitudinal axis of the pylon to which the duct is securely mounted. Each duct preferably has an inlet opening submerged within a body of water, and an outlet opening arranged above the body of water such that an air chamber is formed between the oscillating water column and the outlet opening, in use. The inlet opening is preferably arranged, in use, above the bend or join between the first and second sections of the duct. Preferably, the inlet opening is submerged such that the inlet opening is arranged below the anticipated lowest wave trough.

### BRIEF DESCRIPTION OF THE DRAWINGS

Preferred embodiments of the invention will now be described, by way of example only, with reference to the accompanying drawings in which:

FIG. 1 is a schematic side view of an offshore platform showing various positions in which an energy extraction module can be mounted to the offshore platform;

FIG. 2 is a schematic partial side view of a first embodiment of an offshore platform according to the invention;

FIG. 3 is a schematic partial side view of a second embodiment of an offshore platform according to the invention; and

FIG. 4 is a schematic perspective view of an embodiment of a plurality of ducts arranged in a circular formation about a column for an offshore platform;

FIG. 5 is a schematic plan view of an embodiment of a wave energy extractor according to the invention;

FIG. 6 is a side view of the wave energy extractor of FIG. 5;

FIG. 7 is a perceptive view of an energy extraction module of the wave energy extractor of FIGS. 5 and 6;

FIG. 8 is a schematic side view of another embodiment of a wave energy extractor according to the invention attached to an offshore platform;

FIG. 9 is a sectional plan view showing one arrangement of the energy extraction modules of the wave energy extractor mounted to the pylons of the offshore platform;

FIG. 10 is a plan view of another arrangement of the energy extraction modules of the wave energy extractor mounted to the pylons of the offshore platform;

FIGS. 11A to 11E shows various alternative arrangements of the energy extraction modules mounted to a pylon of the offshore platform;

FIG. 12 is schematic side view of an energy extraction module in which the duct has a first and second sections for changing the course of an oscillating water column;

FIG. 13 is a schematic side view of an energy extraction module in which the duct has four sections for changing the course of an oscillating water column;

FIG. 14 is a side view of an embodiment of a wave energy extraction system according to the invention, incorporating the duct of FIG. 12;

FIG. 15 is a plan view of two alternative arrangements incorporating four or two of the ducts of FIG. 12; and

FIG. 16 is a schematic side view of another embodiment of a wave energy extractor according to the invention, attached to an offshore platform and incorporating the duct of FIG. 12.

### PREFERRED EMBODIMENTS OF THE INVENTION

Referring to the drawings, the invention provides an offshore platform 1. The platform 1 includes a support structure in the form of four interconnected rigid columns 2. The rigid columns 2 support a workstation, in the form of a deck 3, in a body of water such as an ocean 4 at an offshore location. The rigid columns 2 are fixedly anchored to the ocean floor.

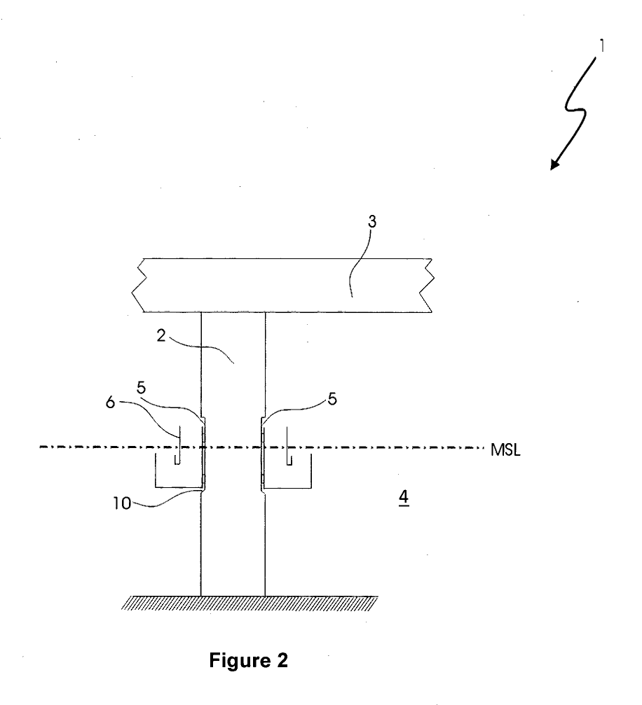

Referring to the embodiment illustrated in FIG. 2, each support column 2 has a mounting formation in the form of a recess 5. The mounting recess 5 extends continuously around the column 2 to define a region of reduced cross-section. The columns 2 are positioned in the body of water such that each recess is arranged at approximately the mean surface level (MSL) of the ocean.

A plurality of ducts 6 are mounted in the mounting recess 5 in a symmetric formation about the column 2. Each duct 6 is configured to receive an oscillating water column from the ocean. The oscillating water column oscillates in response to the rise and fall of ocean waves passing the duct 6.

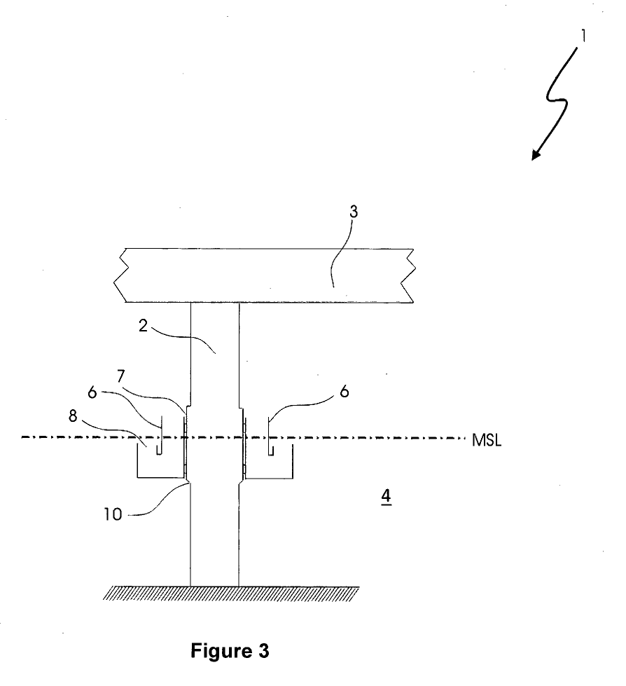

Referring now to an alternative embodiment illustrated in FIG. 3, the mounting formation is in the form of a projection such as an annulet 7 which projects outwardly from an outer surface and encircles the column 2. As shown in FIG. 3, several ducts 6 are mounted to the annulet 7.

Each duct 6 is mounted to the mounting recess 5 or annulet 7 such that an inlet 8 of the duct 6 is submerged within the ocean 4 to a depth below the lowest anticipated wave trough and an outlet 9 of the duct 6 is above the highest anticipated wave peak. Each duct is securely mounted to the column 2 such that the inlet 8 of the duct 6 is held at a predetermined fixed height above the ocean floor.

Reinforcing means 10 is fixed on the column 2 adjacent to the mounting formation in order to increase its load rating for supporting the static and dynamic forces applied to the support structure by the ducts mounted thereto.

The oscillations of the oscillating water column generate a fluid flow in the form of a bidirectional airflow. The bidirectional airflow is used to drive an energy extraction module 11 associated with the ducts 6. A separate energy extraction module 11 is preferably associated with each duct 6.

Each energy extraction module 11 includes a turbine 12 in fluid communication with the duct 6 such that the turbine 12 can be driven by the bidirectional airflow generated by the oscillating water column.

The energy extraction module 11 includes an electrical generating means in the form of an electrical generator 13 coupled to the or each turbine for generating electrical energy.

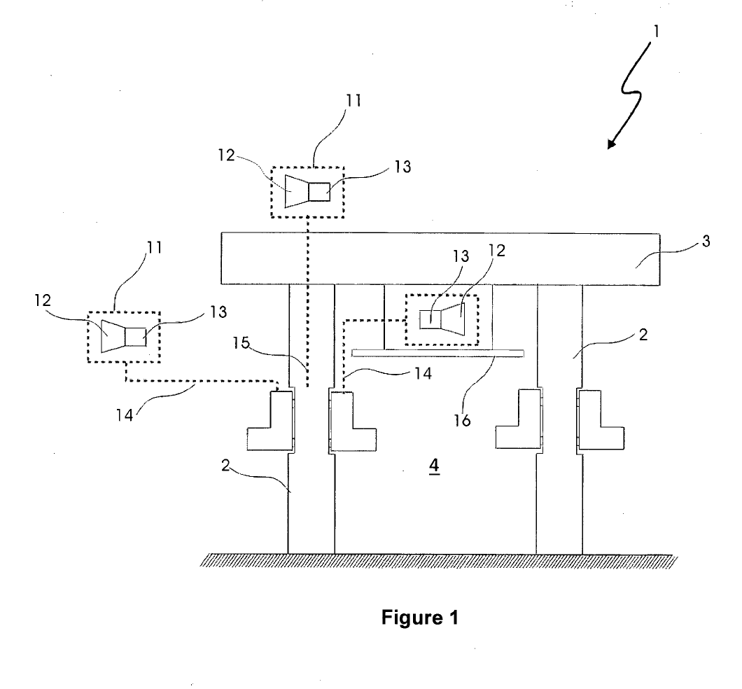

Referring to FIG. 1, the energy extraction modules 11 can be mounted in a variety of different positions relative to the ducts 6. A conduit 14 or an internal passage 15 through the column 2 is used to provide a flow path for the directional airflow to the turbine 12. As shown in FIG. 1, the energy extraction module 11 can be mounted on the column 2 adjacent to the associated duct 6. Alternatively, a support platform 16 can be arranged beneath the deck 3 for supporting the energy extraction modules 11. In a further alternative, the energy extraction modules 11 are arranged on an upper working surface 17 of the deck 3.

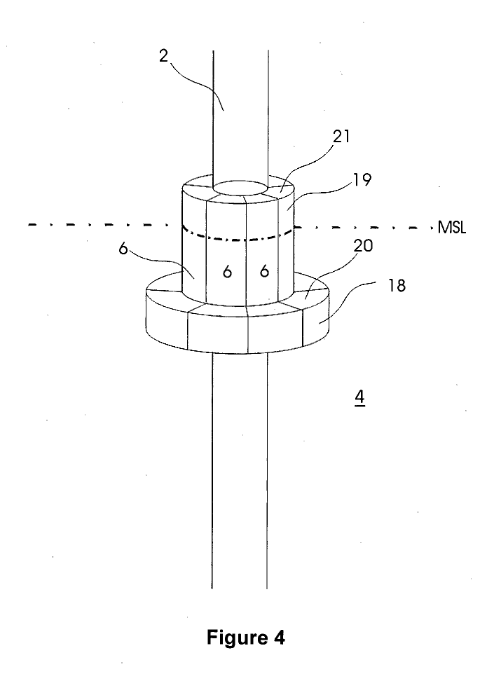

Referring now to the embodiment illustrated in FIG. 4, a group of ducts 6 is mounted to the mounting formation of the column 2 in a circular formation. Each duct 6 is generally J-shaped having an inlet section 18 which is shorter than the outlet section 19. The inlet and outlet openings (20, 21) are arranged to be in an operatively upper surface of the first and second sections of the duct 6, respectively.

It will be appreciated by those skilled in the art that, in other preferred embodiments, the ducts 6 and energy extraction modules 11 can have different configurations in order to account for the intended orientation of a particular module relative to the prevailing ocean wave and/or to assist in maintenance procedures. For example, smaller ducts 6 may be fitted to the inner sides of the columns 2 which are more difficult to reach.

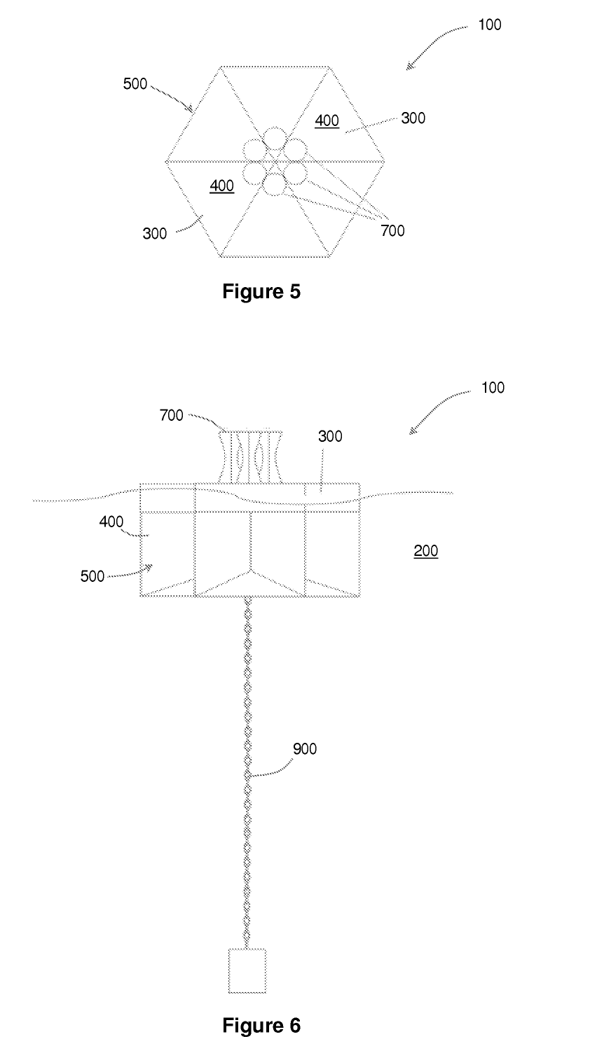

Turning now to FIG. 5 in which an embodiment of a wave energy extraction system 100 is illustrated. The system 100 is arranged in a body of water such as an ocean 200.

The wave energy extraction system 100 includes a support structure in the form of a support frame (not shown) to which a plurality of energy extraction modules 300 are connected in fixed relation relative to each other. In the embodiment of FIG. 5, the support frame defines a central axis about which six energy extraction modules 300 are coaxially arranged in a symmetrical hexagonal formation.

It will be appreciated that the symmetrical formation of the energy extraction modules is not limited to hexagonal formations but could be any suitable symmetrical formation, including circular, square or other polygonal formations.

Each energy extraction module 300 has a duct 400 for receiving an oscillating water column from the ocean 200. The ducts 400 have an inlet opening 500 which is submerged below the mean surface level (MSL) of the ocean 200 for receiving the oscillating water column, and an outlet opening 600 extending above the MSL such that an air chamber is formed between the oscillating water column and the outlet opening 600. As will be described in greater detail below, the oscillating water column oscillates in response to the rise and fall of the oceans waves passing across the duct 400. These oscillations create pressure differentials in the air chamber resulting a fluid flow in the form of a bidirectional airflow.

A turbine 700 is connected to the outlet opening 600 of each duct 400 such that the turbine 700 is in fluid communication with the duct 400. The turbine 700 has a rotor (not shown) which is driven by the bidirectional airflow generated by the oscillating water column. An electrical generator 800 is operatively coupled to each turbine 700 for rotation by the rotor to generate electrical energy.

In the embodiment of FIG. 5, the energy extraction modules 300 including the duct 400, the turbine 700, and the electrical generator 800 are all advantageously constructed to have a substantially identical configuration. That is, the duct 400, the turbine 700, and the electrical generator 800 of each energy extraction module 300 is formed using the same components and configured to be the same size and shape and thus have equal maximum operating capacities.

It will be appreciated by those skilled in the art that the use of energy extraction modules 300 of substantially identical configuration which are arranged in symmetrical formation provides that the combined total electrical energy generated by the system 100 to be substantially constant regardless of the prevailing wave direction. Advantages in terms of reduced design and construction costs are provided by the use of identically configured energy extraction modules 300. This in turn leads to an improved and more commercially viable power-to-cost ratio for the system 100 as a whole.

The energy extraction modules 3 are arranged in the ocean 200 to face in different directions relative to each other and thus relative to the direction of travel of the prevailing ocean wave. As most clearly shown in FIG. 6, the support frame and energy extraction modules 300 are held in a desired fixed position and orientation in the ocean by a mooring system 900. The mooring system 900 holds the ducts 300 at a pre-determined height above the ocean floor.

The embodiment shown in FIGS. 5 and 6 advantageously requires only a single mooring for the entire wave energy extraction system 100. It will be appreciated that the use of a single mooring system is advantageous as this significantly reduces the complexity of the overall structure and thus also reduces the overall cost associated with constructing, commissioning and maintenance procedures.

In the embodiment of FIG. 5, the hexagonal formation includes six energy extraction modules 3 concentrically arranged about the central axis. One energy extraction module faces directly towards the incoming wave, one module faces at +60 degrees relative to the incoming wave, one module faces at −60 degrees relative to the incoming wave, one module faces at +120 degrees relative to the incoming wave, one module faces at −120 degrees relative to the incoming wave, and one module faces at +180 degrees relative to the incoming wave.

It will be appreciated by those skilled in the art that with each substantially identical energy extraction module 300 facing in a different direction relative to the others, the independent oscillating water column associated with each module will oscillate between peaks and troughs of different magnitudes, depending on the direction which that energy extraction module is facing relative to the prevailing ocean wave.

As the energy extraction modules 300 are held in fixed relation relative to the prevailing ocean wave, the performance of each module 300 will depend on the orientation of that particular module 300 with respect to the incoming wave. For example, an energy extraction module 300 which faces directly at the incoming wave will operate at close to 100% working capacity. In contrast, those modules 300 which face away from the incoming wave by an angle ‘α’, will operate below the maximum capacity depending on the angle of orientation. In particular, the working capacity of a module decreases as the angle at which the module faces away from the wave increases.

Referring to FIG. 5 for example, the energy extraction modules orientated at an angle of ±60 degrees relative to the incoming wave operate at approximately 85% capacity, modules angled at ±120 degrees relative to the incoming wave operate at approximately 75% capacity and the module facing away from the incoming wave (i.e. orientated at 180 degrees) operate at approximately 60% capacity.

If the wave direction changes, each energy extraction module will operate at a different working capacity depending on its current angle of orientation with respect to the direction of the incoming wave. In particular, as the wave direction changes, at least some of the units will be oriented at a lesser angle or will face more directly towards the incoming wave and will begin to operate at a higher capacity. Similarly, some energy extraction modules will be orientated at a greater angle or face further away from the incoming wave and therefore operate at a lower working capacity. However, the total power output of the system will remain essentially the same for all wave directions.

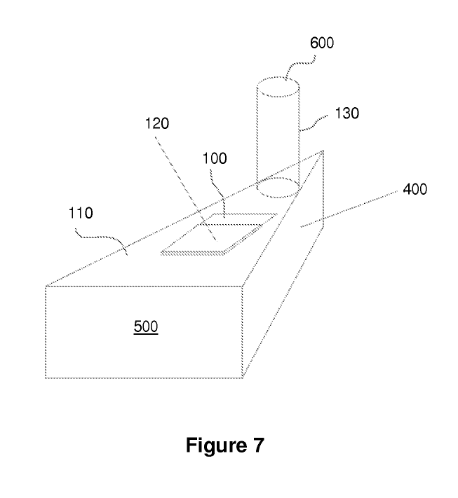

As most clearly shown in FIG. 7, each duct has tapered side walls, with the widest point at or near the inlet opening of the associated duct. It will be appreciated that the use of tapered ducts facilitates the construction of circular or polygonal formations, particularly those with modules sharing common or abutting side walls.

Referring again to FIG. 7, each energy extraction module 300 has a dynamic resonance control for dynamically varying the resonant frequency of the duct 400 of the associated module 300. The dynamic resonance control is used to match the resonant frequency of the ducts 400 of the system 100 to the frequency of the prevailing ocean wave. The dynamic resonance control includes a tuning aperture 110 in a wall 111 of the associated duct 4 and a selectively slidable cover or gate 120 for selectively adjusting the size of the tuning aperture between a fully opened position and a closed position. The cover 120 is slidable to intermediate positions between the fully opened and closed positions in order to provide fine tuning of the opening 110 to match the resonant frequency of the duct 400 to the frequency of the prevailing ocean wave.

The dynamic resonance control includes sensing means in the form of a magnitude sensor 130 for sensing the magnitude of the oscillations of the oscillating water column within the duct 400, which are indicative of the period of the prevailing ocean wave. The slidable cover is in communication with the magnitude sensor 130 such that signals from the sensor are used to initiate movement of the cover to tune the resonant frequency of the duct to correspond with that of the current wave conditions.

As most clearly shown in FIG. 7, the duct can be configured such that the magnitude sensor 130 measures vertical oscillations of the OWC in an outlet section of the duct 400, and the tuning aperture 101 and gate 120 are arranged on an upper wall 111 of an inlet section of the duct such that the gate moves substantially horizontally in response to the sensor signals to open or close the tuning aperture.

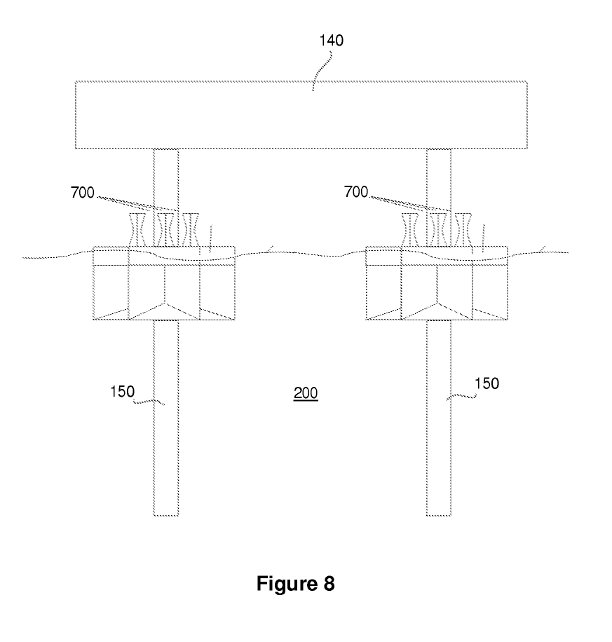

Referring now to FIGS. 8 to 11, another embodiment of a wave energy extraction system 100 is illustrated. As most clearly shown in FIG. 8, an offshore rigid support structure in the form of an immobile oil platform or rig 140 is located in a body of water such as an ocean 200. The oil rig 140 has four legs in the form of pylons 150 fixedly anchored to the ocean floor. Each pylon 150 is preferably formed of formed of steel and/or concrete.

A plurality of energy extraction modules 300 are securely mounted to the pylons of the oil rig via a mounting means in the form of a mounting bracket (not shown) or the like.

Each energy extraction module 300 has a duct 400 for receiving an oscillating water column from the ocean 200. The ducts 4 of the energy extraction modules 300 are held at a predetermined fixed height above the ocean floor.

In the illustrated embodiment, the duct 400 of each module 300 is held at the same height above the ocean floor. It will of course be appreciated that in other preferred embodiments, the ducts can be held at different relative heights above the ocean floor.

In this embodiment, the energy extraction modules 300 have substantially identical configurations. However, in other preferred forms the modules can be configured to have different configurations in order to account for the intended orientation of a particular module relative to the prevailing ocean wave.

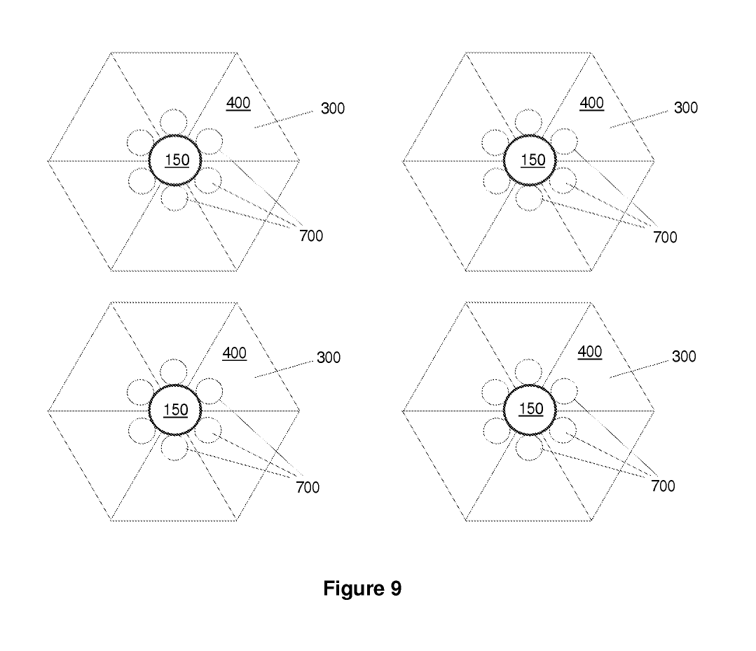

With reference to FIG. 9, the energy extraction modules 300 are arranged in a symmetrical formation about the four pylons 150 of the offshore platform 140. The same symmetrical formation is formed about each leg of the offshore oil rig.

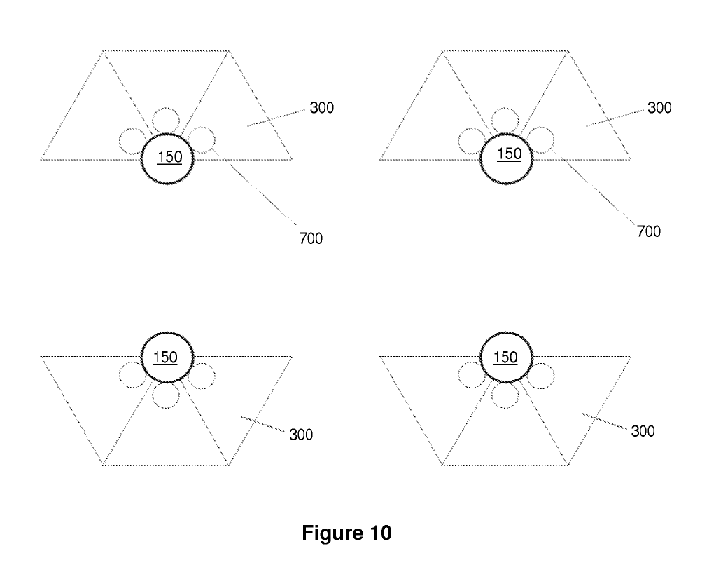

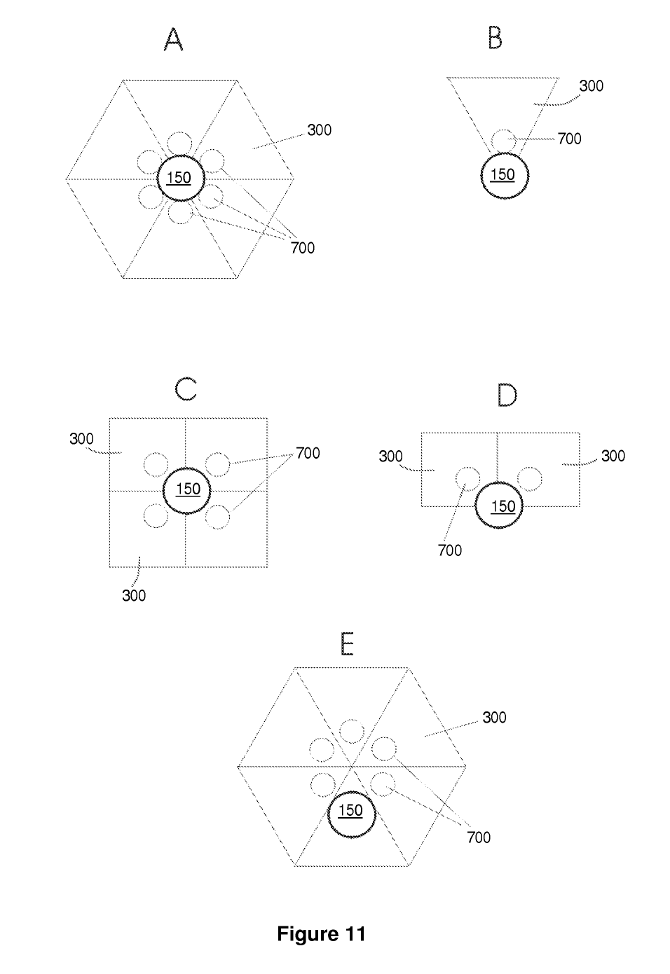

With reference to FIG. 10, an alternative arrangement of the modules 300 is shown in which the energy extraction modules are mounted on the legs of the oil rig to face in different directions relative to the prevailing ocean wave. Further examples of symmetric and asymmetric formations of modules 300 for mounting to the pylons of the oil rig are shown in FIGS. 11A to 11E.

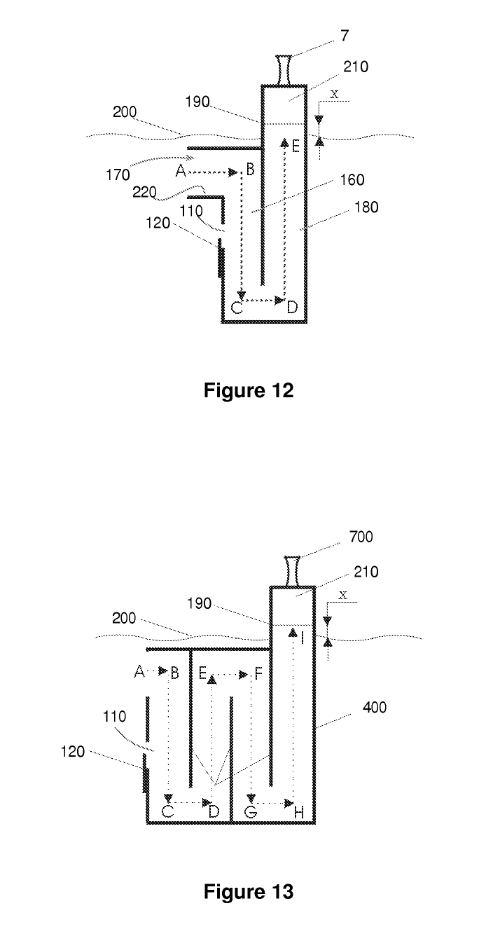

Referring now to FIG. 12, an embodiment of a duct 400 which is particularly suitable for use in the energy extraction modules 3 mounted to the pylons 150 of an oil rig 140 is shown. In this embodiment, the duct 400 of each energy extraction module 300 has a first section 16 defining an inlet opening 170 and a second section 180 defining an outlet opening 190. The duct 400 is configured to be substantially U-shaped wherein the first and second sections (160, 180) are substantially parallel to one another such that the oscillating water column changes course as the water column flows from the first section 160 to the second section 180, or vice versa. The embodiment of FIG. 12 has an optional intake pipe 220. In other forms, this intake pipe 220 is not used and the inlet opening 190 is defined by the end of the first section 160 and faces directly upwardly towards the surface of the ocean 200.

FIG. 13 shows a further embodiment of a duct with four sections. In this duct, the oscillating water column changes course four times as the water column flows from one section to the next as it flows through the duct.

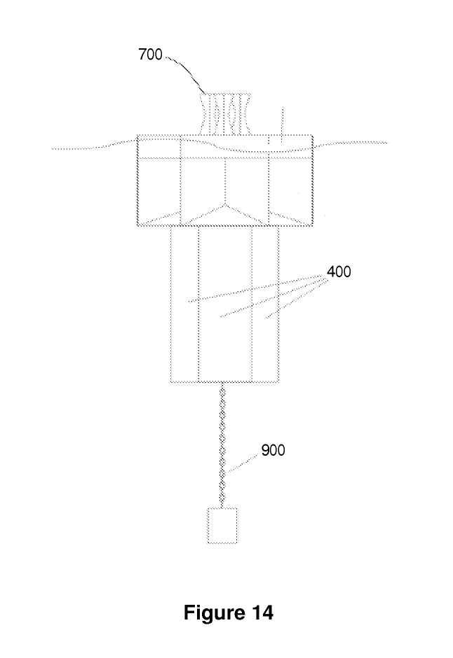

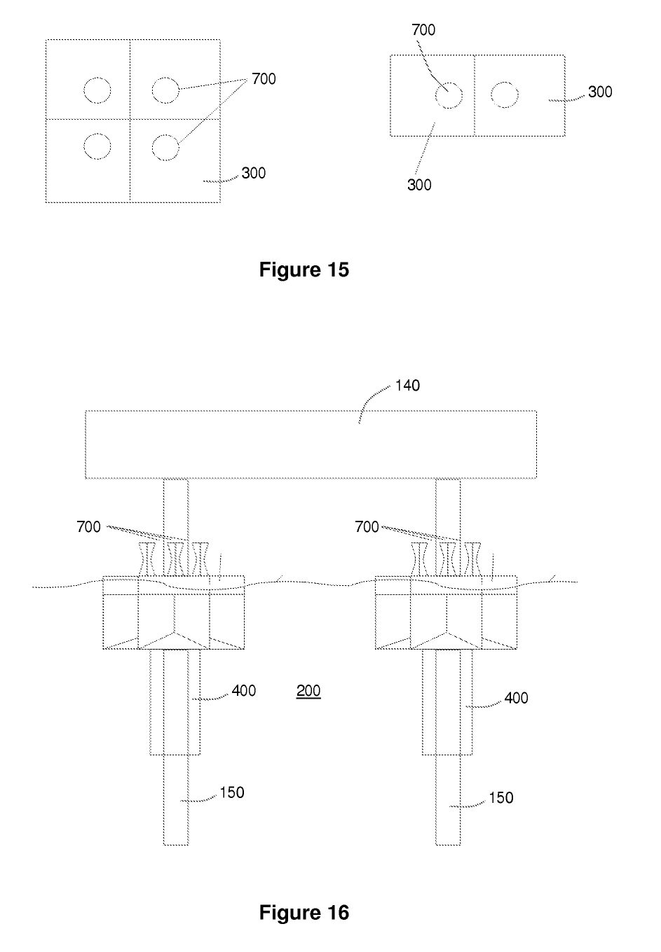

With reference to FIGS. 14 and 16, the ducts of FIGS. 12 and 13 are mounted in a substantially vertical orientation to the pylons 150 of the oil rig 140. That is, the longitudinal axis of each duct (or each section of duct) is substantially parallel to the longitudinal axis of the pylon 150 to which the duct is securely mounted. The inlet opening 170 is submerged within the surface of the ocean and arranged, in use, to be above the bend or join between the first and second sections of the duct such that the inlet opening 170 is arranged below the anticipated lowest wave trough.

The outlet opening 190 is arranged above the surface of the ocean such that an air chamber 210 is formed between the oscillating water column and the outlet opening 190, in use.

A turbine 700 is in fluid communication with each duct 400 such that the turbine 700 can be driven by the airflow generated by the oscillating water column.

The wave energy extraction system preferably includes electrical generating means in the form of an electrical generator coupled to the turbines for generating electrical energy.

The electrical energy generated by the electrical generator or generators can be fed to an electrical grid. Alternatively, the electrical energy can be fed to an energy storage means such as, for example, a battery for later use. The stored energy can be used to supply power to the offshore platform and thus can be advantageously used instead of, or at least to reduce the extent of use of, diesel generators commonly used to supply electrical power to offshore oil rigs or remote communities.

Accordingly, the present invention, at least in its preferred embodiments, provides a wave energy extraction system which advantageously operates more effectively through the use of a rigid, substantially immovable support structures. Preferred forms of the invention enable a wave energy extraction system to be far most commercially viable due to a combination of increased performance and significant reductions in cost outlays, whereby the cost-to-power ratio is improved. The system in certain preferred forms can improve the efficiency of wave energy conversion by up to fifty percent.

Preferred embodiments of the system advantageously enable the total power output of the system to be predominately independent of the prevailing wave direction. In preferred forms, the system advantageously operates more effectively through the use of a rigid, substantially immovable system. The system in preferred forms also provides a compact system which is not only simpler to construct and maintain, but advantageously operates closer to the surface of the ocean thus making use of the higher energy available at these reduced depths. In these and other respects, the invention in its preferred embodiments, represents a practical and commercially significant improvement over the prior art.

Although the invention has been described with reference to specific examples, it will be appreciated by those skilled in the art that the invention may be embodied in many other forms.

What is claimed is:

1. An offshore platform including:
a support structure for supporting a workstation in a body of water at an offshore location, the support structure having a mounting formation; and
at least one duct mounted to the mounting formation, the duct being configured to receive an oscillating water column from the body of water wherein oscillations of the oscillating water column generate a fluid flow for driving an energy extraction module.

2. An offshore platform according to claim 1, wherein two or more ducts are mounted to the mounting formation.

3. An offshore platform according to claim 2, wherein one or each duct is mounted to the mounting formation such that an inlet of the duct is submerged within the body of water and an outlet of the duct is above the body of water.

4. (canceled)

5. An offshore platform according to claim 1, wherein the duct is mounted such that the inlet of the duct is held at a predetermined fixed height above the floor of the body of water.

6. (canceled)

7. (canceled)

8. (canceled)

9. (canceled)

10. An offshore platform according to claim 1, wherein the support structure is positioned in the body of water such that the mounting formation is arranged at approximately the mean surface level of the body of water.

11. An offshore platform according to claim 1, wherein the support structure includes at least one a rigid column or pylon.

12. An offshore platform according to claim 6, wherein the support structure includes two or more rigid columns, the two or more rigid columns being interconnected and held in fixed spaced apart relation relative to one another.

13. (canceled)

14. (canceled)

15. (canceled)

16. (canceled)

17. An offshore platform according to claim 1, wherein the two or more ducts are arranged in a symmetrical formation about the support structure.

18. An offshore platform according to claim 1, wherein reinforcing means is fixed to the support structure to increase its load rating for supporting the static and dynamic forces applied to the support structure by the ducts mounted thereto, in use.

19. An offshore platform according to claim 9, wherein the reinforcing means is fixed on or adjacent to the mounting formation of the support structure.

20. (canceled)

21. (canceled)

22. (canceled)

23. An offshore platform according to claim 1, wherein the energy extraction module includes a turbine in fluid communication with the duct such that the turbine can be driven by the fluid flow generated by the oscillating water column.

24. An offshore platform according to claim 1, wherein the fluid flow from each duct is bidirectional and is used to drive a single turbine.

25. An offshore platform according to claim 11, wherein a separate turbine is associated with each duct and driven by the fluid flow generated by the associated oscillating water column.

26. An offshore platform according to claim 1, wherein the energy extraction module includes an electrical generating means coupled to the or each turbine for generating electrical energy.

27. A support structure for an offshore platform located in a body of water, the support structure including:
a column;
a mounting formation associated with the column; and
at least one oscillating water column duct for a wave energy extraction system, the oscillating water column duct being mounted to the mounting formation such that the duct is held at a predetermined fixed height relative to the mean surface level of the body of water.

28. A support structure according to claim 15, including mounting means for mounting the duct to the column, the mounting means being adapted to reinforce the column to thereby increase the load rating of the column.

29. A support structure according to claim 15, wherein separate reinforcing means is fixed to the column to increase its load rating for supporting the static and dynamic forces applied to the column by the at least one oscillating water column duct mounted thereto.

30. A support structure according to claim 15, wherein the column defines a flow passage for a fluid flow generated by an oscillating water column oscillating within the duct wherein the fluid flow can be used to drive an energy extraction module.

31. A support structure according to claim 18, wherein the flow passage is an internal hollowed passage allowing flow inside the column.

32. A support structure according to claim 18, wherein the flow passage is defined by a conduit arranged in a groove formed in an outer surface of the column.

33. (canceled)
